(19) United States
(12) Patent Application Publication
(10) Pub. No.: US 2025/0145177 A1
(43) Pub. Date: May 8, 2025

(54) METHOD OF SETTING AN AUTONOMOUS DRIVING ROUTE USING WIRELESS COMMUNICATION ENVIRONMENT INFORMATION, AND ITS DEVICE

(71) Applicant: Korea University Research and Business Foundation, Seoul (KR)

(72) Inventors: In Kyu LEE, Seoul (KR); Jae Wan KIM, Seoul (KR)

(21) Appl. No.: 18/935,015

(22) Filed: Nov. 1, 2024

(30) Foreign Application Priority Data
Nov. 2, 2023 (KR) 10-2023-0149763

(51) Int. Cl. B60W 60/00; G01C 21/34

(52) U.S. Cl. CPC B60W 60/001; G01C 21/3492; B60W 2420/403; B60W 2554/40; B60W 2556/40; B60W 2556/45

(57) ABSTRACT

A method of setting an autonomous driving route using wireless communication environment information for a vehicle capable of driving in an autonomous driving mode comprises: a first step of receiving regional wireless communication environment information from a communication company server; a second step of receiving real-time traffic information from a control server; a third step of receiving a destination from a user; and a fourth step of setting an autonomous driving route from a current location of the user or a starting point input by the user to the destination by reflecting the wireless communication environment information and the real-time traffic information.

### BACKGROUND OF THE INVENTION

### Field of the Invention

The present invention relates to a method of setting an autonomous driving route using wireless communication environment information and a device therefor, and more specifically, to a method of setting an autonomous driving route using wireless communication environment information and a device therefor, which can provide an optimal autonomous driving environment by setting a route to include regions provided with a wireless communication environment capable of smoothly receiving data required for autonomous driving of a vehicle.

### Background of the Related Art

Autonomous driving techniques are developed recently to allow vehicles and other means of transportation to operate by themselves without human control or operation. For example, autonomous driving using a vehicle means that some or all of the functions of driving the vehicle are performed without a human driver, and an autonomous vehicle may operate autonomously without operation of a human driver on the basis of vehicle driving environment information.

Specifically, for autonomous driving, information on driving environments should be collected through cameras and sensors installed in the vehicle. However, as collection of information through the cameras and sensors may not be smooth due to the limitations such as weather, illuminance, and the like, it is also possible to receive information on the driving environment through communication. In other words, techniques that allow a vehicle to receive and exchange information with surrounding objects such as roads, surrounding vehicles, and the like through wired or wireless communication networks to understand the driving environment are called V2X techniques (including Vehicle to Vehicle (V2V), Vehicle to Infrastructure (V2I), Vehicle to Nomadic Device (V2N), Vehicle to Pedestrian (V2P), and the like). Through the V2X techniques, it is possible to systematically communicate with next-generation Intelligent Transport Systems (ITS) and receive data required for autonomous driving.

In other words, for autonomous driving of a vehicle, it needs to receive various data on the driving environment in the neighborhood, and receiving data on the driving environment quickly and accurately in real time before or during driving is a very important factor for safe and smooth autonomous driving of the vehicle.

However, in order to implement smooth autonomous driving, a large amount of data on the driving environment should be received, and in particular, a data reception speed higher than a predetermined speed and reliable data quality should be guaranteed to receive data in real time even when the vehicle is driving. However, in reality, there is a limitation in that such a communication environment is difficult to establish in all regions of the country including islands and mountainous regions. Therefore, in the case of autonomous driving according to conventional techniques, reception of necessary data may not be smooth while the vehicle is driving according to the communication environment of a corresponding region, and therefore, autonomous driving itself is not possible or errors or accidents may occur during autonomous driving, and there is a problem in that a threat to the safety of a user and people around the user may occur.

The present invention relates to a new and advanced technique capable of providing an optimal autonomous driving environment by setting a route to include regions provided with a wireless communication environment capable of smoothly receiving data required for autonomous driving of a vehicle in order to solve the problems.

Korean Patent Publication No. 10-2468814 (Nov. 15, 2022)

### SUMMARY OF THE INVENTION

Therefore, the present invention has been made in view of the above problems, and it is an object of the present invention to provide a method of setting an autonomous driving route using wireless communication environment information and a device therefor, which can receive regional wireless communication environment information from a communication company server in advance, and set an autonomous driving route to preferentially include regions where data required for autonomous driving can be reliably received.

In addition, another object of the present invention is to provide a method of setting an autonomous driving route using wireless communication environment information and a device therefor, which can improve reliability of wireless communication environment information by repeatedly performing a process of constructing a wireless communication environment map based on the wireless communication environment information received from a communication company server, performing a test on the wireless communication environment map, and updating the wireless communication environment map by reflecting the result of the test.

In addition, still another object of the present invention is to provide a method of setting an autonomous driving route using wireless communication environment information and a device therefor, which can set criteria of wireless communication environment information for reliably receiving data required for actual autonomous driving more accurately by storing driving information of a vehicle driven along a set autonomous driving route to be mapped to the wireless communication environment information and utilizing the information as a dataset for artificial intelligence learning.

The technical problems of the present invention are not limited to the technical problems mentioned above, and unmentioned other technical problems will be clearly understood by those skilled in the art from the following description.

To accomplish the above objects, according to an embodiment of the present invention, there is provided a method of setting an autonomous driving route using wireless communication environment information for a vehicle capable of driving in an autonomous driving mode, the method comprising: a first step of receiving regional wireless communication environment information from a communication company server; a second step of receiving real-time traffic information from a control server; a third step of receiving a destination from a user; and a fourth step of setting an autonomous driving route from a current location of the user or a starting point input by the user to the destination by reflecting the wireless communication environment information and the real-time traffic information.

According to an embodiment, the first step may be performed to receive wireless communication environment information from each regional base station of the communication company server, and receive at least one or more pieces of wireless communication environment information such as frequency bands that can be used in the region, an amount of communication traffic generated in the region, data transmission and reception reliability, data processing amount, data transmission and reception efficiency, and data transmission and reception signal strength.

According to an embodiment, the method of setting an autonomous driving route may further comprise, after the first step, step 1-1 of constructing a wireless communication environment map according to a regional data reception level based on the received wireless communication environment information; step 1-2 of performing an autonomous driving test on the wireless communication environment map; and step 1-3 of updating the wireless communication environment map by reflecting the result of the test, wherein steps 1-1 to 1-3 may be performed repeatedly.

According to an embodiment, the fourth step may be performed to set a shortest distance or minimum travel time and distance to the destination as the autonomous driving route, and set the autonomous driving route to preferentially include regions where the wireless communication environment information or the real-time traffic information reaches predetermined criteria for reliably receiving data required for autonomous driving of the vehicle.

According to an embodiment, the method of setting an autonomous driving route may further comprise, after the fourth step, step 4-1 of confirming whether the wireless communication environment information or the traffic information of each region within the set autonomous driving route reaches predetermined criteria for reliably receiving data required for autonomous driving of the vehicle.

According to an embodiment, the method of setting an autonomous driving route may further comprise, after step 4-1, step 4-2 of re-setting, when a region that does not reach the predetermined criteria is included in the set autonomous driving route, the autonomous driving route to include, instead of the region, other regions that reach the predetermined criteria without going out of the autonomous driving route more than a predetermined range.

According to an embodiment, the method of setting an autonomous driving route may further comprise, after step 4-1, step 4-3 of re-setting, when a region that does not reach the predetermined criteria is included in the set autonomous driving route, the autonomous driving mode of the vehicle in the corresponding region.

According to an embodiment, step 4-3 may be performed in a manner of releasing all or part of the autonomous driving mode of the vehicle so that data required for autonomous driving of the vehicle may be collected from the vehicle.

According to an embodiment, the method of setting an autonomous driving route may further comprise, after the fourth step, a fifth step of receiving driving information of a vehicle driven along the set autonomous driving route; a sixth step of storing the driving information of the vehicle to be mapped to regional wireless communication environment information; and a seventh step of setting predetermined criteria for reliably receiving data required for autonomous driving of the vehicle on the basis of the stored information, wherein the fifth to seventh steps may be performed repeatedly.

To accomplish the above objects, according to another embodiment of the present invention, there is provided a device for setting an autonomous driving route using wireless communication environment information for a vehicle capable of driving in an autonomous driving mode, the device comprising: a data receiving unit for receiving regional wireless communication environment information from a communication company server and receiving real-time traffic information from a control server; a route setting unit for setting an autonomous driving route from the current location of a user or a starting point input by the user to a destination input by the user by reflecting the wireless communication environment information and the real-time traffic information; and a memory unit for storing driving information of a vehicle driven along the autonomous driving route, wherein the route setting unit may set the shortest distance or minimum travel time and distance to the destination as the autonomous driving route, and set the autonomous driving route to preferentially include regions where the wireless communication environment information or the real-time traffic information reaches predetermined criteria for reliably receiving data required for autonomous driving of the vehicle.

According to the present invention as described above, regional wireless communication environment information can be received from a communication company server in advance, an autonomous driving route may be set to preferentially include regions where data required for autonomous driving can be reliably received, and through this, there is an effect of preventing a problem of generating a data reception error due to deterioration of communication environments while a vehicle is driving along the autonomous driving route.

In addition, according to the present invention as described above, there is an effect of improving reliability of wireless communication environment information by repeatedly performing a process of constructing a wireless communication environment map based on the wireless communication environment information received from a communication company server, performing a test on the wireless communication environment map, and updating the wireless communication environment map by reflecting the result of the test.

In addition, according to the present invention as described above, there is an effect of setting criteria of wireless communication environment information for reliably receiving data required for actual autonomous driving more accurately by storing driving information of a vehicle autonomously driven along a set route to be mapped to the wireless communication environment information and utilizing the information as a dataset for artificial intelligence learning, and setting an optimal autonomous driving route without a problem in receiving data required for autonomous driving.

The effects of the present invention are not limited to the effects mentioned above, and unmentioned other effects will be clearly understood by those skilled in the art from the following description.

### BRIEF DESCRIPTION OF THE DRAWINGS

FIG. 1 is a view for explaining an autonomous driving route setting device using wireless communication environment information according to an embodiment of the present invention.

FIG. 2 is a view for explaining an autonomous driving route setting device using wireless communication environment information according to another embodiment of the present invention.

FIG. 3 is a flowchart for explaining a method of setting an autonomous driving route using wireless communication environment information according to an embodiment of the present invention.

FIG. 4 is a flowchart for explaining a process of constructing a wireless communication environment map according to an embodiment of the present invention.

FIG. 5 is a view for explaining a wireless communication environment map according to an embodiment of the present invention.

FIG. 6 is a view for explaining a process of setting an autonomous driving route using wireless communication environment information according to an embodiment of the present invention.

FIGS. 7A to 7C are flowcharts for explaining a process of correcting an autonomous driving route that is set according to an embodiment of the present invention.

FIG. 8 is a flowchart for explaining a method of setting an autonomous driving route using wireless communication environment information according to another embodiment of the present invention.

FIG. 9 is a table for explaining a process of setting and readjusting predetermined criteria for setting an autonomous driving route according to another embodiment of the present invention.

### DETAILED DESCRIPTION OF THE PREFERRED EMBODIMENT

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, detailed embodiments of the present invention will be described with reference to the drawings.

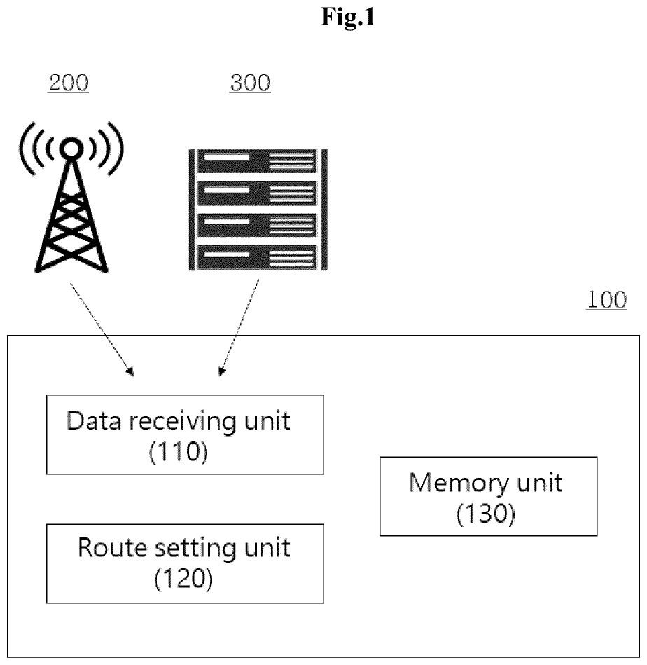

FIG. 1 is a view for explaining an autonomous driving route setting device using wireless communication environment information according to an embodiment of the present invention.

However, this is only a preferred embodiment for achieving the objects of the present invention, and it goes without saying that some components may be added or deleted as needed and the functions performed by one component may be performed together with another component.

An autonomous driving route setting device 100 using wireless communication environment information according to an embodiment of the present invention is an autonomous driving route setting device for a vehicle capable of operating in an autonomous driving mode, and may include a data receiving unit 110 for receiving regional wireless communication environment information from a communication company server 200 and receiving real-time traffic information from a control server 300, a route setting unit 120 for setting an autonomous driving route from the current location of a user or a starting point input by the user to a destination input by the user by reflecting the wireless communication environment information and the real-time traffic information, and a memory unit 130 for storing driving information of a vehicle driven along the autonomous driving route, and it goes without saying that the device may further include additional configurations required to achieve the objects of the present invention.

The autonomous driving route setting device 100 using wireless communication environment information may include a wired or wireless communication function, and may receive various information required for autonomous driving from the communication company server 200 or the control server 300 before the vehicle is driven, as well as while the vehicle is driving.

The communication company server 200 means a server that constructs and provides a wireless communication infrastructure in which a plurality of users may transmit and receive voices, videos, text, images, data, and the like regardless of the location through a terminal. In order to construct such a wireless communication infrastructure, a base station may be installed in each region to provide a wireless communication environment. That is, the communication company server 200 designs and installs a base station considering available wireless communication resources, such as the amount of communication traffic generated in each region, to provide the wireless communication infrastructure to users. In the present invention, regional wireless communication environment information of the communication company server 200 is received and utilized to set an autonomous driving route.

For example, the data receiving unit 110 may receive wireless communication environment information from each regional base station of the communication company server 200, and may receive at least one or more pieces of wireless communication environment information such as frequency bands that can be used in the region, the amount of communication traffic generated in the region, data transmission and reception reliability, data processing amount, data transmission and reception efficiency, and data transmission and reception signal strength.

In addition, the data receiving unit 110 may also receive real-time traffic information from the control server 300, and may set an autonomous driving route that reflects changes in the real-time communication environment based on the traffic information received from the control server 300. In particular, according to the present invention, an intelligent antenna system that reflects changes in the real-time wireless communication environment may be utilized to set an autonomous driving route that allows stable vehicle driving by applying artificial intelligence technologies, such as reinforcement learning, in association with existing autonomous driving methods.

The route setting unit 120 is a configuration that sets an autonomous driving route to a destination input by a user, and may function to set an autonomous driving route from the current location of the user received from the user (or user's vehicle, user terminal, or the like) or a starting point input by the user to the destination.

In addition, the route setting unit 120 may be any one among an artificial intelligence processor and software of a form widely known in the technical field, and may perform an operation on at least one application or program for setting an autonomous driving route according to an embodiment of the present invention. For example, the route setting unit 120 may include an artificial intelligence learning model, which derives a predetermined result value by utilizing at least one or more data values or variables, or a combination of various operation algorithms.

Here, the route setting unit 120 sets the shortest distance or minimum travel time and distance to the destination as an autonomous driving route, and may set the autonomous driving route to preferentially include regions where the wireless communication environment information or the real-time traffic information reaches predetermined criteria for reliably receiving data required for autonomous driving of the vehicle. Accordingly, the present invention may set an optimal autonomous driving route that can smoothly receive data required for autonomous driving in a more stable wireless communication environment.

The memory unit 130 is a configuration in which driving information of the vehicle driven along the set autonomous driving route is stored, and may store various information, commands and/or information, and data, and load a computer program such as software or the like for setting an autonomous driving route using wireless communication environment information according to an embodiment of the present invention. Although the memory unit 130 is shown in FIG. 1 as a configuration included in the device 100 of the present invention, it goes without saying that various storage media may be used as the memory unit 130.

In addition, the memory unit 130 may store one or more pieces of software and a large quantity of data values. The memory unit 130 may be any one among nonvolatile memory such as Read Only Memory (ROM), Erasable Programmable ROM (EPROM), Electrically Erasable Programmable ROM (EEPROM), and flash memory, a hard disk (HDD), an auxiliary storage medium (SSD), a detachable disk, and any form of computer-readable recording medium widely known in the technical field of the present invention.

Here, the memory unit 130 stores driving information of the vehicle driven along the set autonomous driving route, and may store the driving information of the vehicle to be mapped to regional wireless communication environment information. The driving information of the vehicle according to the wireless communication environment information stored in the memory unit 130 may be utilized as a learning dataset that constitutes the artificial intelligence learning model of the present invention, and the route setting unit 120 may utilize the information stored in the memory unit 130 and the learning result to set an optimal autonomous driving route.

That is, according to the present invention, it may be determined whether the wireless communication environment information is sufficient to reliably receive data required for actual autonomous driving of the vehicle based on the driving information of the vehicle according to the wireless communication environment information stored in the memory unit 130, and in addition, as the driving information of the vehicle is repeatedly and cumulatively stored in the memory unit 130, the criteria for good data reception level according to the wireless communication environment information may be set more accurately.

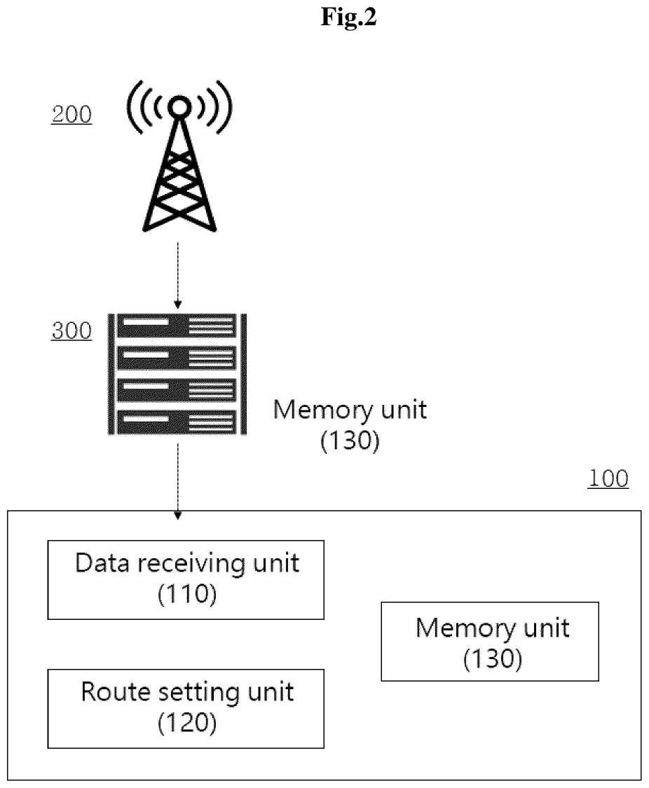

FIG. 2 is a view for explaining an autonomous driving route setting device reflecting wireless communication environment information according to another embodiment of the present invention. The autonomous driving route setting device 100 of the present invention may also receive the wireless communication environment information and the real-time traffic information through the control server 300.

That is, according to another embodiment of the present invention, the control server 300 may receive regional wireless communication environment information from the communication company server 200 and provide it to the autonomous driving route setting device 100 together with the real-time traffic information, or the control server 300 may appropriately combine the regional wireless communication environment information received from the communication company server 200 with the real-time traffic information and provide it to the autonomous driving route setting device 100.

In this case, the control server 300 may provide the wireless communication environment information and the real-time traffic information to the autonomous driving route setting device 100 of the present invention so that an optimal autonomous driving route may be set considering regions where data required for autonomous driving can be reliably received based on the regional wireless communication environment information received from the communication company server 200 and regions where a large amount of data can be transmitted and received on the basis of the real-time traffic information.

The autonomous driving route setting device 100 using wireless communication environment information according to the present invention briefly described above may be in the form of an independent device, for example, an electronic device or a server (including a cloud). Here, the electronic device may a portable device that is easy to carry, such as a smart phone, a tablet PC, a notebook PC, a PDA, a PMP, or the like, as well as a device such as a desktop PC, a server device, or the like fixedly installed and used in one location, and any electronic device having software installed therein and a network function may be used.

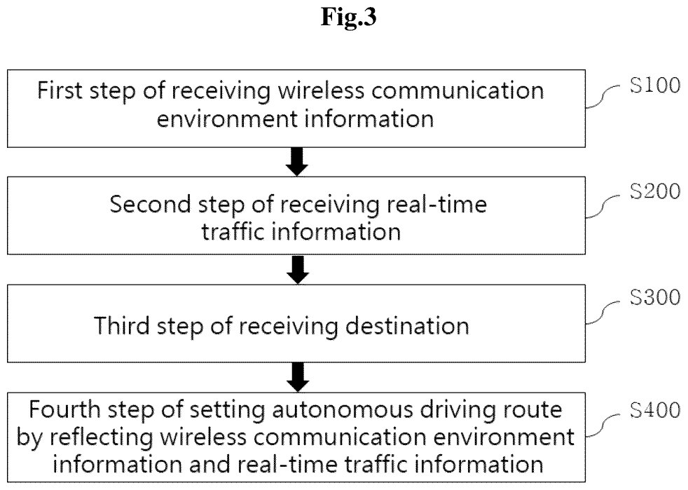

Hereinafter, on the assumption that the autonomous driving route setting device 100 using wireless communication environment information according to the present invention is in the form of a “server”, a “system”, or an “electronic device” among the electronic devices that are independent devices, a method of setting an autonomous driving route using wireless communication environment information according to the present invention performed by the software installed in the “server”, “system”, or “electronic device” will be described in more detail with reference to FIGS. 3 to 9.

FIG. 3 is a flowchart for explaining a method of setting an autonomous driving route reflecting wireless communication environment information according to an embodiment of the present invention, and it is a flowchart for explaining representative steps of a method of setting an autonomous driving route for a vehicle capable of driving in an autonomous driving mode. However, the steps are only a preferred embodiment for achieving the objects of the present invention, and it goes without saying that some steps may be added or deleted as needed, and any one step may be performed to be included in another step.

Meanwhile, it is assumed that each step is performed through an autonomous driving route setting device (FIG. 1 and FIG. 2) reflecting wireless communication environment information according to an embodiment of the present invention, and the steps illustrated and described in FIG. 3 may be understood as steps performed by the software installed in the device.

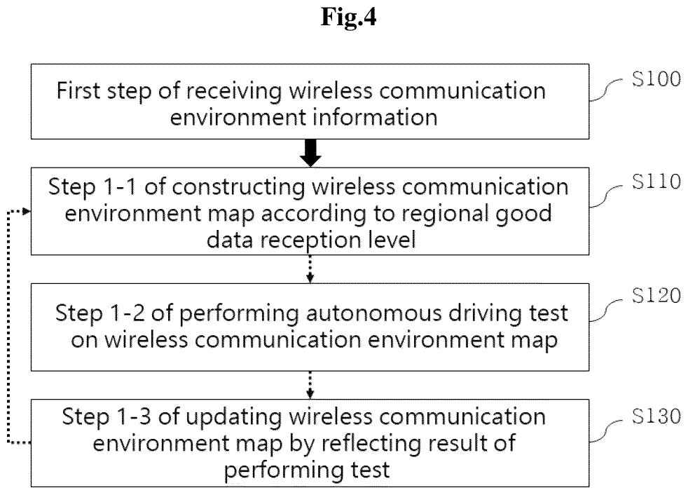

As shown in FIG. 4, a method of setting an autonomous driving route using wireless communication environment information according to an embodiment of the present invention may be performed to include a first step of receiving regional wireless communication environment information from a communication company server (S100), a second step of receiving real-time traffic information from a control server (S200), a third step of receiving a destination from a user (S300), and a fourth step of setting an autonomous driving route from the current location of the user or a starting point input by the user to the destination by reflecting the wireless communication environment information and the real-time traffic information (S400).

The first step of receiving wireless communication environment information from a communication company server (S100) may be understood as a process of receiving wireless communication environment information secured by the communication company server to design and install a base station considering available wireless communication resources, such as the amount of communication traffic generated in each region, to provide the wireless communication infrastructure to users.

That is, the first step (S100) of the present invention may be performed to receive wireless communication environment information from each regional base station of the communication company server, and may receive at least one or more pieces of wireless communication environment information such as frequency bands that can be used in the region, the amount of communication traffic generated in the region, data transmission and reception reliability, data processing amount, data transmission and reception efficiency, and data transmission and reception signal strength.

Here, the method of setting an autonomous driving route using wireless communication environment information according to an embodiment of the present invention may receive regional wireless communication environment information that may determine whether data required for autonomous driving can be reliably received through the first step (S100), and in particular, since the wireless communication environment information can be downloaded in advance before the vehicle travels, and the required information can be secured in advance without being restricted by the wireless communication environment information while the vehicle actually travels, separate communication traffic for confirming the wireless communication environment information does not occur.

Next, the second step of receiving real-time traffic information from the control server (S200) may be performed. The second step (S200) may be understood as a step of confirming the amount of data transmitted and received in a predetermined period of time by a network device, and when there is a lot of real-time traffic, it means that there are many users of the server or system who transmit and receive data, and thus the present invention may confirm whether the data required for autonomous driving is received reliably by confirming the real-time traffic information.

Here, the second step (200) may be performed at the same time as the first step (S100), before the first step (S100), or in a manner of receiving information that the control server generates by receiving the wireless communication environment information of the first step (S100) and appropriately combining it with the real-time traffic information. That is, the first step (S100) and the second step (S200) are performed to receive the wireless communication environment information or/and the real-time traffic information that may determine whether data required for autonomous driving of the vehicle can be reliably received, and the order and method thereof are not limited to embodiments of the present invention.

Next, the third step of receiving a destination from a user (S300) may be performed. The third step (S300) is a step of receiving a final destination for setting an autonomous driving route along which the vehicle will move from the starting point, and although it is preferable to perform after the first step (S100) and the second step (S200) described above are performed, in some cases, it may be performed before the first step (S100) and the second step (S200) are performed or between the first step (S100) and the second step (S200).

When the third step (S300) is performed before the first step (S100) and/or the second step (S200), as the travel path to the destination input at the third step (S300) may be predicted first, the first step (S100) and the second step (S200) may be performed to selectively receive only wireless communication environment information and real-time traffic information of the travel path or a region included in a predetermined range of the travel path, and in this case, there is an advantage in that data can be received more efficiently.

Next, the fourth step of setting an autonomous driving route to the destination by reflecting the wireless communication environment information and the real-time traffic information (S400) may be performed. The fourth step (S400) may be understood as a step of setting an autonomous driving route along which the vehicle will actually travel, and the current location of the user (the current location of the user terminal or the current location of the user's vehicle) received from the user or a starting point input by the user may be set as the starting point of the autonomous driving route.

Here, the fourth step (S400) may set the shortest distance or the minimum travel time and distance to the destination as the autonomous driving route, and in particular, may set the autonomous driving route to preferentially include regions where the wireless communication environment information or the real-time traffic information reaches predetermined criteria for reliably receiving data required for autonomous driving of the vehicle.

In other words, unlike conventional cases of setting an autonomous driving route by simply considering a distance or time, the present invention may set an autonomous driving route by considering whether data required during autonomous driving can be reliably received by using the wireless communication environment information and/or the real-time traffic information received in advance, and through this, the present invention may set a more stable and safe autonomous driving route that can minimize generation of unexpected emergency situations or accidents due to data reception errors.

FIG. 4 is a flowchart for explaining a process of constructing a wireless communication environment map according to an embodiment of the present invention. Hereinafter, a process of constructing a wireless communication environment map that can be used for setting an autonomous driving route by reflecting regional wireless communication environment information received in advance in the present invention will be described in more detail with reference to FIG. 4.

As shown in FIG. 4, after the first step of receiving regional wireless communication environment information from a communication company server (S100), step 1-1 of constructing a wireless communication environment map according to a regional data reception level based on the received wireless communication environment information (S110), step 1-2 of performing an autonomous driving test on the wireless communication environment map (S120), and step 1-3 of updating the wireless communication environment map by reflecting the result of the test (S130) may be performed.

That is, according to the present invention, as a wireless communication environment map according to the regional data reception level based on wireless communication environment information received from a communication company server is constructed, the wireless communication environment map may be utilized in setting an autonomous driving route to a destination.

In particular, as an autonomous driving field test is performed on the wireless communication environment map and the wireless communication environment map is updated by reflecting data obtained through the test result, the present invention may reduce errors in the wireless communication environment map and increase the degree of completion, and through this, an autonomous driving route may be set using the wireless communication environment map, and safety of autonomous driving according to the set autonomous driving route can be improved actually.

In addition, the present invention may also repeatedly perform steps 1-1 to 1-3 (S110 to S130) of constructing and updating the wireless communication environment map, and in this case, the error between the wireless communication environment map constructed based on the wireless communication environment information secured in advance and the wireless communication environment of an actual autonomous driving route can be minimized. For example, as steps 1-1 to 1-3 (S110 to S130) are repeatedly performed and learned, various unexpected situations may be learned to appropriately respond even when the base station system of the telecommunications company server is unstable.

This repetitive learning process on the wireless communication environment map may be performed in advance through the control server, and as the learning process is performed in a Neural Processing Unit (NPU) system optimized for artificial intelligence, in which only the information required for actual autonomous driving and the parts that require real-time learning are mounted on the autonomous vehicle, power consumption and computational load of the NPU system can be minimized.

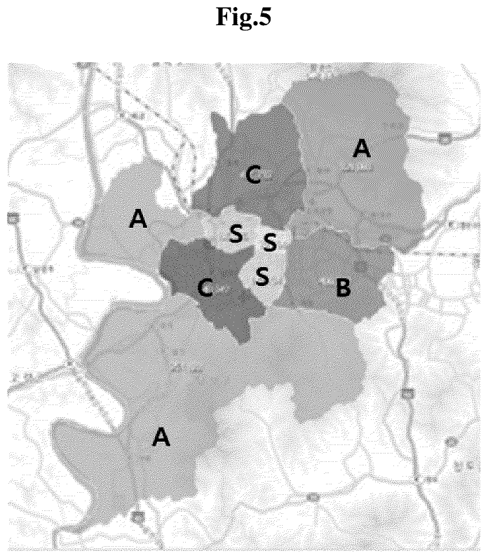

FIG. 5 is a view for explaining a wireless communication environment map according to an embodiment of the present invention.

As shown in FIG. 5, the level of the wireless communication environment information or the real-time traffic information may be displayed to be different in each region according to the degree of reliably receiving the data required for autonomous driving of the vehicle. For example, it may be displayed as level S when the data reception rate is 95% or higher, level A when the rate is 90% or higher, level B when the rate is 80% or higher, level C when the rate is 70% or higher, and level D when the rate is 60% or higher. The level may be displayed in various ways such as numerals or grades, in addition to the alphabets, and may also be expressed as visual effects such as various colors, shades, gradients, or the like.

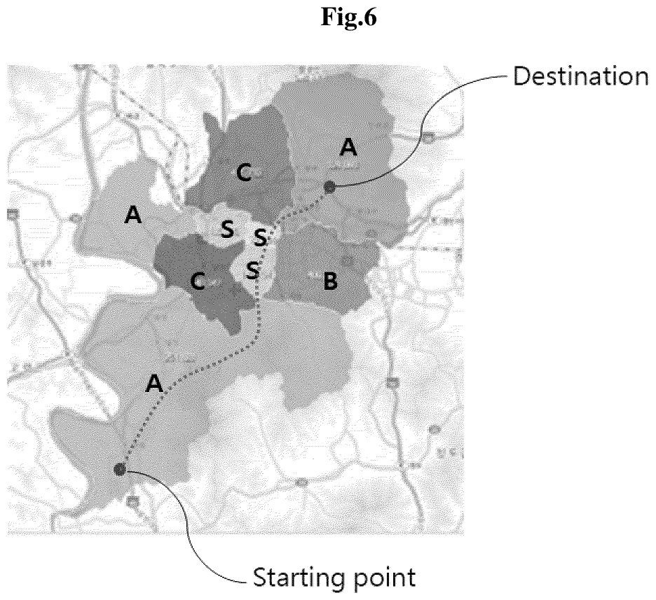

FIG. 6 is a view for explaining a fourth step of setting an autonomous driving route in more detail by reflecting wireless communication environment information according to an embodiment of the present invention, and for example, it is a view for explaining a process of setting an autonomous driving route by utilizing the wireless communication environment map of FIG. 5.

As shown in FIG. 6, the shortest distance or the minimum travel time and distance from the starting point input by the user (or the current location of the user terminal or the user's vehicle) to the destination input by the user may be set as the autonomous driving route. In particular, the present invention does not set the autonomous driving route only by considering the shortest distance or the minimum travel time, but may set the autonomous driving route by considering whether the data required for autonomous driving can be received reliably.

That is, the present invention sets an autonomous driving route by utilizing the wireless communication environment map of FIG. 5, in which the level of the wireless communication environment information or the real-time traffic information is displayed to be different in each region according to the degree of reliably receiving data required for autonomous driving of the vehicle, and the autonomous driving route is set to preferentially include regions where the wireless communication environment information or the real-time traffic information reaches predetermined criteria for reliably receiving data required for autonomous driving of the vehicle.

For example, when a route considering only the shortest distance (or minimum travel time and distance) from the starting point to the destination in FIG. 6 includes a region (level C) that does not reach predetermined criteria for reliably receiving data required for autonomous driving of the vehicle, the present invention may set a route detouring this region and including regions (level S) that reach the predetermined criteria for reliably receiving data required for autonomous driving of the vehicle as an optimal autonomous driving route.

Through this, the present invention may solve the problem of not being able to properly receive data required for autonomous driving as the data reception state is poor during autonomous driving of a vehicle, and may provide a more stable and safe optimal autonomous driving route by blocking in advance the risk of unexpected situations or safety accidents that may occur due to data reception error.

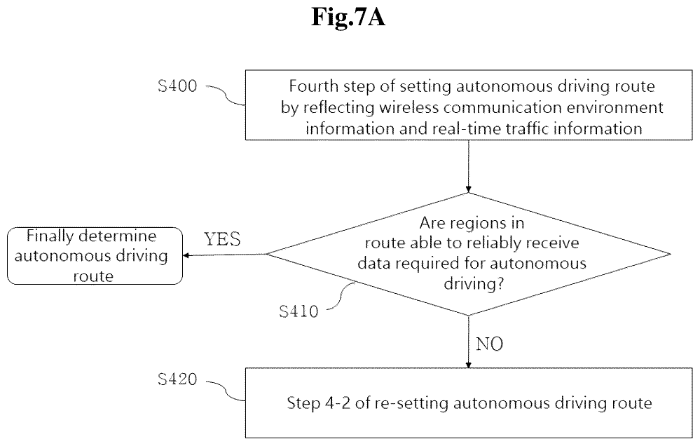

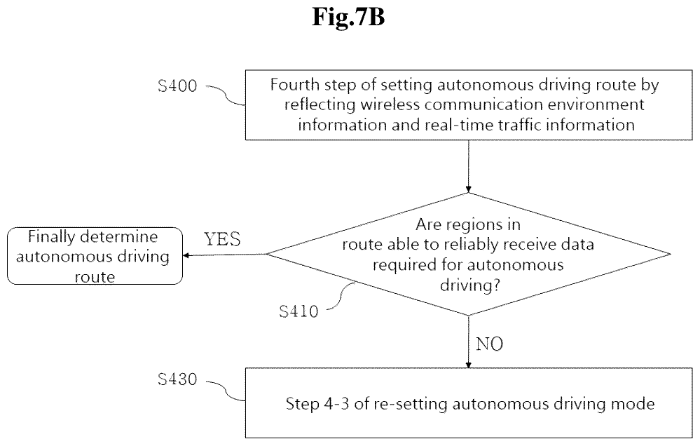

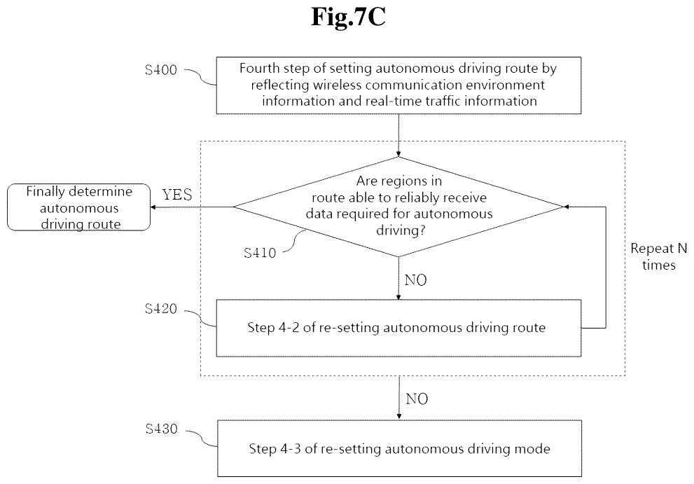

In addition, the present invention may continuously provide a more stable and safe autonomous driving route through correction of an autonomous driving route set in the manner described above, and the process of correcting an autonomous driving route that is set according to an embodiment of the present invention will be described below through FIGS. 7A to 7C.

Referring to FIG. 7A, after the fourth step of setting an autonomous driving route by reflecting the wireless communication environment information and the real-time traffic information (S400), step 4-1 of confirming whether the wireless communication environment information or the traffic information of each region within the set autonomous driving route reaches predetermined criteria for reliably receiving data required for autonomous driving of the vehicle (S410) may be performed, and when the data reception state in all regions included in the autonomous driving route is determined to be reliable at step 4-1 (S410), the autonomous driving route set at the fourth step (S400) may be confirmed as is.

However, when it is determined at step 4-1 (S410) that the autonomous driving route includes a region where the data reception state is poor (a region where the data reception level does not reach predetermined criteria), step 4-2 of re-setting the autonomous driving route set at step 4 (S400) (S420) may be performed. At this point, step 4-2 (S420) may be performed in a manner of re-setting the autonomous driving route to include other regions where data reception reaches the predetermined criteria instead of the regions where the data reception level does not reach the predetermined criteria, and more preferably, it may be performed to include regions where data reception is good without going out of a predetermined range (for example, a range where the route or travel time excessively goes out compared to the existing route) from the preset autonomous driving route.

Referring to FIG. 7B, after the fourth step of setting an autonomous driving route by reflecting the wireless communication environment information and the real-time traffic information (S400), step 4-1 of confirming whether the wireless communication environment information or the traffic information of each region within the set autonomous driving route reaches predetermined criteria for reliably receiving data required for autonomous driving of the vehicle (S410) may be performed, and when the data reception state in all regions included in the autonomous driving route is determined to be reliable at step 4-1 (S410), the autonomous driving route set at the fourth step (S400) may be confirmed as is.

However, when it is determined at step 4-1 (S410) that the autonomous driving route includes a region where the data reception state is poor (a region where the data reception level does not reach predetermined criteria), step 4-3 of re-setting the autonomous driving mode of the vehicle in the corresponding region (S430) may be performed.

Here, step 4-3 (S430) may be performed in a manner of releasing all or part of the autonomous driving mode of the vehicle so that data required for autonomous driving of the vehicle may be collected in a manner without regard to the wireless communication environment. For example, when the vehicle passes through a region with a poor wireless communication environment where reception of data required for autonomous driving is poor, step 4-3 (S430) may be performed by lowering the level of autonomous driving mode of the vehicle to directly collect some data from the vehicle or by disabling the autonomous driving mode of the vehicle to directly collect all the required data from the vehicle.

More specifically, when a vehicle passes through a region with a poor wireless communication environment, step 4-3 (S430) may be performed in a manner of releasing all or part of the autonomous driving mode of the vehicle so that the vehicle itself may appropriately collect data required for autonomous driving from cameras or sensors provided in the vehicle or information previously stored in the vehicle according to the result of artificial intelligence learning, and furthermore, may be performed in a manner of re-setting to an appropriate autonomous driving mode so that the vehicle driver may directly intervene in operation of the vehicle when reception and collection of data do not satisfy the requirements needed for autonomous driving.

In addition, in order to react more sensitively to such changes in the wireless communication environment, the present invention may perform step 4-2 of re-setting the autonomous driving route (S420) and step 4-3 of re-setting the autonomous driving mode (S430) together.

Referring to FIG. 7C, after step 4-1 of confirming whether predetermined criteria for reliably receiving data required for autonomous driving of the vehicle (S410) is satisfied, step 4-2 of re-setting the autonomous driving route (S420) may be repeatedly performed at least N times, and when the re-set autonomous driving route includes a region at a level of poor data reception although step 4-2 (S420) is repeatedly performed N times, step 4-3 of re-setting the autonomous driving mode (S430) may be additionally performed.

As described above, even after an autonomous driving route is set using the wireless communication environment information and/or the real-time traffic information, the present invention may additionally perform a process of confirming whether a region with poor data reception is included in the autonomous driving route while the vehicle is driving along the autonomous driving route, and when a region where data reception required for autonomous driving is poor is included, the route may be re-set or the autonomous driving mode may be re-set so that data may be collected in a manner without regard to the wireless communication environment.

Through this, the present invention may re-set an optimized autonomous driving environment suitable for autonomous driving even when an unexpected emergency situation (e.g., a sudden deterioration of the wireless communication environment such as radio interference or the like) occurs while the vehicle is driving along a preset autonomous driving route, and in particular, although a situation in which the wireless communication environment required for autonomous driving is not provided occurs suddenly, the present invention may sensitively response to the change in the wireless communication environment according to the changes in the surrounding natural or artificial environment using cameras or LiDAR sensors, as well as the intelligent array antenna system mounted on the vehicle, and optimize wireless communication performance for autonomous driving.

In addition, as another embodiment of the present invention, the driving information of the vehicle driven along the set (or re-set) autonomous driving route may be stored in the memory unit to be mapped to wireless communication environment information, and this may be utilized as a learning dataset for an artificial intelligence learning model, and through this, accuracy of the criteria for determining a good data reception level of the wireless communication environment information can be improved, and the wireless communication environment information may be utilized for setting an autonomous driving route.

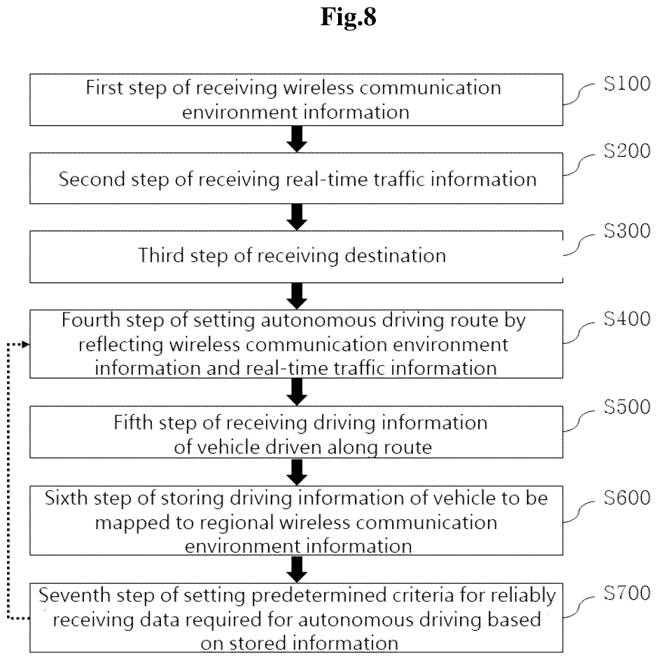

FIG. 8 is a flowchart for explaining a method of setting an autonomous driving route using wireless communication environment information according to another embodiment of the present invention. As shown in FIG. 8, after the fourth step of setting an autonomous driving route by reflecting the wireless communication environment information and the real-time traffic information (S400), a fifth step of receiving driving information of a vehicle driven along the set autonomous driving route (S500), a sixth step of storing the driving information of the vehicle to be mapped to regional wireless communication environment information (S600), and a seventh step of setting predetermined criteria for reliably receiving data required for autonomous driving of the vehicle on the basis of the stored information (S700) may be additionally performed.

Through this, the present invention may not only set an autonomous driving route by utilizing previously received wireless communication environment information, but also minimize errors of actual autonomous driving results according to the wireless communication environment information by receiving actual driving information of a vehicle driven along the set autonomous driving route, storing the actual driving information to be mapped to the wireless communication environment information, and performing an artificial intelligence learning process using the stored information as a learning dataset.

In particular, the present invention may also repeatedly perform the fifth step (S500) to the seventh step (S700), improve accuracy of result values of the repeatedly performed artificial intelligence learning, and more accurately set or readjust the criteria of a good data reception level required for autonomous driving to a level close to reality almost without an error value.

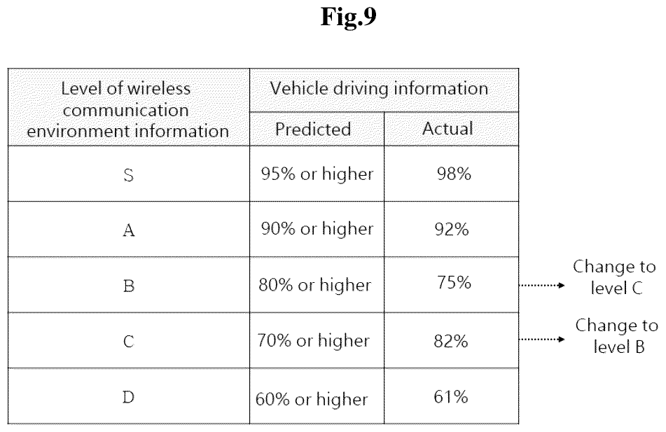

FIG. 9 is a table for explaining a process of setting and readjusting predetermined criteria for setting an autonomous driving route according to another embodiment of the present invention.

Referring to FIG. 9, a wireless communication environment information level may be set on the basis of a prediction value according to how reliably the wireless communication environment information received from a communication company server may receive data required for autonomous driving of a vehicle, and in the present invention, a preset wireless communication environment information level may be set or re-set based on an actual result value of information on the operation of the vehicle driven along an autonomous driving route reflecting the set wireless communication environment information level.

For example, when the good data reception level expected based on the wireless communication environment information received from the communication company server is predicted to be 95% or higher and the result value of actual driving information of the vehicle in a region set to level S is 98%, the wireless communication environment information level of the region does not need to be re-set and may be maintained as is.

However, when the good data reception level expected based on the wireless communication environment information received from the communication company server is predicted to be 80% or higher and the result value of actual driving information of the vehicle in a region set to level B is 75%, the wireless communication environment information level of the region needs to be re-set to be lowered to level C, and when the expected good data reception level is predicted to be 70% or higher and the result value of actual driving information of the vehicle in a region set to level C is 82%, the wireless communication environment information level of the region needs to be re-set to be increased to level B.

Therefore, the present invention may set an optimal autonomous driving route by predicting a good data reception level on the basis of wireless communication environment information received from a communication company server in advance, and may also minimize an error between a predicted value and an actual value by re-setting the good data reception level on the basis of actual driving information of a vehicle autonomously driving along the set autonomous driving route, and therefore, the present invention may further improve accuracy of setting an autonomous driving route using the wireless communication environment information.

As described above, the present invention may receive regional wireless communication environment information from a communication company server and set an autonomous driving route that preferentially includes regions where data required for autonomous driving can be reliably received using the same, and may smoothly receive required data during autonomous driving of a vehicle through this.

In addition, as the present invention constructs a wireless communication environment map according to the regional data reception level based on the received wireless communication environment information, performs a test on the wireless communication environment map, and updates the wireless communication environment map by reflecting the result value, reliability of the wireless communication environment map can be improved.

In addition, as the present invention receives actual driving information of a vehicle driven along a set autonomous driving route and repeatedly performs artificial intelligence learning using the actual driving information as a learning dataset, predetermined criteria for determining whether the wireless communication environment information may reliably receive data required for actual autonomous driving may be more accurately set or re-set, and through this, accuracy of the autonomous driving route set using wireless communication environment information can be improved.

Furthermore, the present invention may confirm whether a preset autonomous driving route includes regions that reach a good data reception level, and when a region with poor data reception is included in the set route, the autonomous driving route or the autonomous driving mode is re-set, and through this, the possibility of a vehicle to pass through a region where the data reception state is poor can be minimized, and although the vehicle passes through a region with poor data reception, more stable and safe autonomous driving is allowed by collecting data required for autonomous driving through the vehicle or increasing intervention of the driver.

Therefore, compared to conventional cases of setting an autonomous driving route considering only the shortest path or minimum travel time to the destination, the present invention may set an optimal autonomous driving route that can smoothly and stably receive required data during autonomous driving, and through this, the risk of unexpected situations or accidents that may occur due to poor data reception or data reception error during autonomous driving of a vehicle can be prevented.

Although the embodiments of the present invention have been described with reference to the attached drawings, those skilled in the art will understand that the present invention can be implemented in other specific forms without changing the technical spirit or essential features thereof. Therefore, it should be understood that the embodiments described above are exemplary in all respects and not restrictive.

### DESCRIPTION OF SYMBOLS

100: Autonomous driving route setting device
110: Data receiving unit
120: Route setting unit
130: Memory unit
200: Communication company server
300: Control server

What is claimed is:

1. A method of setting an autonomous driving route using wireless communication environment information for a vehicle capable of driving in an autonomous driving mode, the method comprising:
a first step of receiving regional wireless communication environment information from a communication company server;
a second step of receiving real-time traffic information from a control server;
a third step of receiving a destination from a user; and
a fourth step of setting an autonomous driving route from a current location of the user or a starting point input by the user to the destination by reflecting the wireless communication environment information and the real-time traffic information.

2. The method according to claim 1, wherein the first step is performed to receive wireless communication environment information from each regional base station of the communication company server, and receive at least one or more pieces of wireless communication environment information such as frequency bands that can be used in the region, an amount of communication traffic generated in the region, data transmission and reception reliability, data processing amount, data transmission and reception efficiency, and data transmission and reception signal strength.

3. The method according to claim 1, further comprising, after the first step,
step 1-1 of constructing a wireless communication environment map according to a regional data reception level based on the received wireless communication environment information;
step 1-2 of performing an autonomous driving test on the wireless communication environment map; and
step 1-3 of updating the wireless communication environment map by reflecting the result of the test, wherein
steps 1-1 to 1-3 may be performed repeatedly.

4. The method according to claim 1, wherein the fourth step may be performed to set a shortest distance or minimum travel time and distance to the destination as the autonomous driving route, and set the autonomous driving route to preferentially include regions where the wireless communication environment information or the real-time traffic information reaches predetermined criteria for reliably receiving data required for autonomous driving of the vehicle.

5. The method according to claim 1, further comprising, after the fourth step, step 4-1 of confirming whether the wireless communication environment information or the traffic information of each region within the set autonomous driving route reaches predetermined criteria for reliably receiving data required for autonomous driving of the vehicle.

6. The method according to claim 5, further comprising, after step 4-1, step 4-2 of re-setting, when a region that does not reach the predetermined criteria is included in the set autonomous driving route, the autonomous driving route to include, instead of the region, other regions that reach the predetermined criteria without going out of the autonomous driving route more than a predetermined range.

7. The method according to claim 5, further comprising, after step 4-1, step 4-3 of re-setting, when a region that does not reach the predetermined criteria is included in the set autonomous driving route, the autonomous driving mode of the vehicle in the corresponding region.

8. The method according to claim 7, wherein step 4-3 is performed in a manner of releasing all or part of the autonomous driving mode of the vehicle so that data required for autonomous driving of the vehicle may be collected from the vehicle.

9. The method according to claim 8, wherein step 4-3 is performed to autonomously determine the data required for autonomous driving of the vehicle according to a result of artificial intelligence learning performed in advance, and collect the data required for autonomous driving of the vehicle using at least one or more among information collected from at least one or more among a camera, a sensor, and an array antenna provided in the vehicle and information already stored in the vehicle.

10. The method according to claim 1, further comprising, after the fourth step,
a fifth step of receiving driving information of a vehicle driven along the set autonomous driving route;
a sixth step of storing the driving information of the vehicle to be mapped to regional wireless communication environment information; and
a seventh step of setting predetermined criteria for reliably receiving data required for autonomous driving of the vehicle on the basis of the stored information, wherein
the fifth to seventh steps may be performed repeatedly.

11. A device for setting an autonomous driving route using wireless communication environment information for a vehicle capable of driving in an autonomous driving mode, the device comprising:
a data receiving unit for receiving regional wireless communication environment information from a communication company server and receiving real-time traffic information from a control server;
a route setting unit for setting an autonomous driving route from the current location of a user or a starting point input by the user to a destination input by the user by reflecting the wireless communication environment information and the real-time traffic information; and
a memory unit for storing driving information of a vehicle driven along the autonomous driving route, wherein
the route setting unit sets the shortest distance or minimum travel time and distance to the destination as the autonomous driving route, and sets the autonomous driving route to preferentially include regions where the wireless communication environment information or the real-time traffic information reaches predetermined criteria for reliably receiving data required for autonomous driving of the vehicle.
